(19) United States
(12) Patent Application Publication
(10) Pub. No.: US 2014/0187692 A1
(43) Pub. Date: Jul. 3, 2014

(54) Impact-Modified Styrenic Polymers Containing Brominated Vinyl Aromatic-Butadiene Copolymer

(71) Applicants: William G. Stobby, Midland, MI (US); Shari L. Kram, Midland, MI (US); Ted A Morgan, Midland, MI (US); Michael L. Lapham, Midland, MI (US); Inken Beulich, Waedenswil (CH); Bruce A King, Midland, MI (US)

(72) Inventors: William G. Stobby, Midland, MI (US); Shari L. Kram, Midland, MI (US); Ted A Morgan, Midland, MI (US); Michael L. Lapham, Midland, MI (US); Inken Beulich, Waedenswil (CH); Bruce A King, Midland, MI (US)

(21) Appl. No.: 14/127,204

(22) PCT Filed: Jun. 27, 2012
(86) PCT No.: PCT/US2012/044296

§ 371 Date: Dec. 18, 2013

Related U.S. Application Data
(60) Provisional application No. 61/507,633, filed on Jul. 14, 2011.
(60) Provisional application No. 61/638,546, filed on Apr. 26, 2012.

(51) Int. Cl. C08F 236/10; C08K 5/52

(52) U.S. Cl. CPC C08F 236/10; C08K 5/52
USPC 524/147; 525/332.3; 524/572; 525/359.1

(57) ABSTRACT

Impact-modified polystyrene resins such as HIPS and ABS resins are blended with a brominated vinyl aromatic-butadiene copolymer. The brominated copolymer is an effective flame retardant in these compositions, allowing in many cases a V-1 rating to be achieved in the UL-94 vertical burn test.

This application claims priority from U.S. Provisional Patent Application No. 61/507,633, filed 14 Jul. 2011, and from U.S. Provisional Patent Application No. 61/638,546, filed 26 Apr. 2012.

Impact-modified styrenic polymer (IMSP) resins are sold in large volumes into applications where rigidity and durability are needed. For example, IMSP resins are used widely as housings for consumer and business electronics such as computers, cellular telephones, personal digital assistant (PDA) devices, televisions, stereos, computer game consoles, various types of modem devices, among many others. These resins are also widely used as linings in consumer appliances such as refrigerators and freezers, and as materials of construction for cases, storage boxes, food storage ware, pipe and many kinds of toys. IMSP resins are also known as rubber-modified styrenic polymer resins and commonly known examples of these resins include high impact polystyrene (HIPS) and acrylonitrile/butadiene/styrene copolymers (ABS).

Many applications require the IMSP resin to resist ignition and/or, if ignited, to resist flame propagation. To meet this requirement, the IMSP resin is usually formulated with one or more flame retardants. Brominated compounds are commonly used for this purpose. These function by thermally decomposing to release HBr, which is believed to be the species that inhibits flame propagation. These brominated compounds include small molecules (molecular weight 1500 g/mol or less) such as hexabromocyclododecane (HBCD), decabromodiphenyl ether, tetrabromobisphenol A, tris-tribromoneopentyl phosphate, bis(2,3-dibromopropylether)tetrabromobisphenol A, as well as brominated aromatic polymers such as brominated polystyrene, brominated aromatic polyacrylates such as poly(pentabromophenyl acrylate), and polymers derived from tetrabromobisphenol A epoxy resins. There are problems associated with each of these types, which limit their effectiveness and their continued acceptance to the industry.

A significant shortcoming of the small molecule types is that they tend to be fugitive. Because they are fugitive, the small molecules tend to “bloom” to the surface of the material, where they cause staining or other cosmetic defects. Once at the surface, the small molecules can be released into the surrounding environment through mechanical action or volatilization. This loss of flame retarding agent though blooming leads to a loss of efficacy, as a portion of the flame retardant often is lost prematurely. As a result, high loadings of these small molecule brominated flame retardants are often needed.

Another problem with small molecule types is that at least some of them are believed to bioaccumulate. Hexabromocyclododecane, long the industry standard brominated FR agent for many organic polymer systems, is being regulated out of use in Europe due to concerns over bioaccumulation.

A third concern with small molecule brominated flame retardants is that they often plasticize the IMSP. The plasticization occurs in part due to a solvation effect. In addition, the IMSP can degrade when hydrogen bromide (HBr) is released from the brominated flame retardant, reducing its molecular weight and increasing the plasticization effect. The plasticization can have an adverse effect on the physical properties of the polymer as well as its performance in certain flammability tests. One aspect of flame resistance is the ability of the resin to retreat from an ignition source, with minimal dripping. An excessively plasticized polymer is more likely to drip rather than retreat. Dripping can promote flame spread if the drips continue to burn. A similar effect is seen when the IMSP is degraded too quickly when HBr is released; its molecular weight drops, reducing the ISMP ability to retreat from an ignition source, and the remaining polymer drips readily, which can contribute to the spread of flame. Large molecule (for example, polymeric) flame retardants typically are less fugitive than are the small molecule types and therefore are less likely exhibit the problems associated with blooming. However, they often thermally depolymerize and can escape from the polymer without releasing HBr. In addition, the large molecule brominated flame retardants used in these applications typically have aromatically bound bromine, which is highly thermally stable. This thermal stability is a significant drawback, because to be effective, the flame retardant must degrade and release HBr within a certain temperature range. The aromatically bound bromine is often too stable and does not release at the correct temperature, which renders these flame retardants relatively ineffective when used by themselves. As a result, either high loadings of the aromatic brominated flame retardant are required, or metal-containing synergists such as antimony trioxide, sodium antimonite, iron oxide, zinc borate, zinc phosphate and zinc stannate and metal phthalocyanines (as described in EP 1724304) must be included with the flame retardant to render the bromine radicals more labile. It would be preferred avoid using these metal-containing synergists if at all possible.

Therefore, there is a desire to provide an effective brominated flame retardant for IMSP resins. Such a brominated flame retardant should be non-fugitive and therefore resist blooming to the polymer surface under conditions of ordinary use. It should be highly effective at reasonable loadings, and preferably does not require the presence of a metal-containing synergist to be effective. Such a brominated flame retardant preferably does not excessively plasticize the IMSP or readily degrade the IMSP during processing or when undergoing ignition in a fire test.

Recently, brominated styrene-butadiene copolymers have been described as useful flame retardants for polystyrene foams. See, e.g. (WO 2008/064774, WO 2008/021417, WO 2008/021418 and WO 2010/080285). Through careful control of the bromination process, styrene-butadiene copolymer can be brominated almost exclusively on aliphatic carbons rather than the aromatic rings of the styrene units of the copolymer. The aliphatically-bound bromine is thermally stable enough that the brominated copolymer can be processed via extrusion foaming processes with little release of HBr, but labile enough to function effectively. The behavior of compact materials under fire conditions are in many ways vastly different than that of cellular polymers, and the performance of flame retardant materials in compact materials cannot be predicted from their performance in cellular polymers. In addition, the performance of flame retardants is often significantly different when blended into different polymers, so their performance in a particular polymer system is not easily predictable based on their performance in other polymer systems. The efficacy of the brominated styrene-butadiene copolymers described in the references cited above has not heretofore been established in IMSP or in compact (non-cellular) polymer systems.

The present invention is in one aspect an impact-modified styrenic polymer resin composition comprising an impact-modified styrenic polymer resin having a brominated vinyl aromatic-butadiene copolymer blended therein, wherein the brominated copolymer (a) has a molecular weight of at least 5,000, as determined by gel permeation chromatography against a polystyrene standard, (b) contains 2.5 to 85 mole-% styrenic monomer units and 15 to 97.5 mole-% butadiene units, (c) has a bromine content of at least 30% by weight of which at least 90 mole-% is bonded to butadiene units and (d) has a five percent weight loss temperature (5% WLT), as determined by thermogravimetric analysis, of at least 200° C.

The impact-modified styrenic polymer resin composition is in the form of a substantially non-cellular (i.e., “compact”) article having a bulk density of at least 700 kg/m³, more preferably at least 900 kg/m³.

The impact-modified styrenic polymer resin composition of the invention generally can be used in the same manner and for the same applications as the impact-modified styrenic polymer by itself and in the same manner and for the same applications as impact-modified styrenic polymers that contain conventional brominated flame retardants. Thus, the composition is useful for making articles such as electronics housings, linings for consumer appliances such as refrigerators and freezers, and as materials of construction for cases, storage boxes, food storage ware and many kinds of toys.

The brominated vinyl aromatic-butadiene copolymer resists blooming, provides excellent flame retardance (as measured by certain standardized tests such as the UL-94 test), and has at most only a small plasticization effect. Although the polystyrene portion of the brominated vinyl aromatic-butadiene copolymer can contribute to fuel generation during the ignition process, it nonetheless delivers equal or superior performance compared to HBCD at equivalent bromine levels. The good fire performance can be achieved even when the composition is devoid of other brominated compounds, metal-containing “synergist” compounds, and/or fading dyes and/or other pigments.

The invention is in addition a method for making an impact-modified styrenic polymer resin article, comprising melt-processing an impact-modified styrenic polymer resin in the presence of a brominated vinyl aromatic-butadiene copolymer to form a shaped melt, and cooling the shaped melt to form the impact-modified styrenic polymer resin article, wherein the brominated copolymer (a) has a molecular weight of at least 10,000, as determined by gel permeation chromatography against a polystyrene standard, (b) contains 2.5 to 85 mole-% styrenic monomer units and 15 to 97.5 mole-% butadiene units, (c) has a bromine content of at least 35% by weight of which at least 90 mole percent is bonded to butadiene units and (d) has a five percent weight loss temperature (5% WLT), as determined by thermogravimetric analysis, of at least 200° C.

The brominated vinyl aromatic copolymer contains vinyl aromatic repeating units, which are formed by polymerizing a vinyl aromatic monomer, and butadiene repeating units, which are formed by polymerizing butadiene. At least some of the butadiene units are brominated as described more fully below.

The vinyl aromatic repeating units preferably are styrene units formed by polymerizing styrene. However, other vinyl aromatic units can be present, including those formed by polymerizing monomers such as α-methyl styrene, 2-, 3- or 4-methyl styrene, other alkyl-substituted styrenes such as ethyl styrene, vinyl naphthalene, alkyl-substituted vinyl naphthalenes, and the like. Mixtures of two or more different types of vinyl aromatic units can be present. The brominated vinyl aromatic-butadiene copolymer contains at least 2.5 mole-% vinyl aromatic units, preferably contains at least 10 mole-% and more preferably at least 20 mole % styrene units. It may contain up to 85 mole-% vinyl aromatic units, but preferably contains no more than 60 mole-% vinyl aromatic units and more preferably contains no more than 40 mole-% vinyl aromatic units. These quantities of vinyl aromatic units include both unbrominated vinyl styrene units and any brominated vinyl styrene units as may be present.

The brominated vinyl aromatic-butadiene copolymer preferably contains at least 15 mole-% butadiene units. It more preferably contains at least 40 mole-% butadiene units and still more preferably contains at least 60 mole-% butadiene units. It may contain as much as 90 mole-% butadiene units, but more preferably contains no more than 80 mole-% butadiene units. These quantities are inclusive of both brominated butadiene units and any unbrominated butadiene units as may be present.

The brominated vinyl aromatic-butadiene copolymer may contain repeating units of other copolymerizable monomers. If present, these other repeating units preferably constitute no more than 20 mole-%, preferably no more than 10 mole-% and more preferably no more than 5 mole-% of the repeating units of the copolymer.

Butadiene polymerizes to form mainly two types of repeating units. One type, referred to herein as “1,2-butadiene units” takes the form

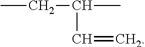

Bromination introduces bromine onto the carbon atoms in the pendant chain. This mainly produces brominated 1,2-butadiene units having the form

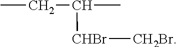

The second main type of butadiene units, referred to herein as “1,4-butadiene” units, take the form —CH₂—CH═CH—CH₂—. In this case, bromination introduces bromine onto the main polymer chain to produce brominated 1,4-butadiene units that are believed to mostly have the form —CH₂—CHBr—CHBr—CH₂—. The proportions of brominated 1,2- and 1,4-butadiene units in the copolymers may vary widely, but it is preferred that at least some of the brominated butadiene units are brominated 1,2-butadiene units. In some embodiments, brominated 1,2-butadiene units constitute at least 60% or at least 70% of the brominated butadiene units in the copolymer and may be in excess of 85% or even in excess of 90% of the brominated butadiene units in the copolymer.

The brominated vinyl aromatic-butadiene copolymer may be a random copolymer, but is preferably a block copolymer such as a diblock copolymer or triblock copolymer. A triblock copolymer preferably includes a central polybutadiene block with terminal blocks of the polymerized vinyl aromatic monomer. The polybutadiene should not form discrete particles or otherwise form a discrete phase separate from the poly(vinyl aromatic) portion of the copolymer.

The brominated vinyl aromatic-butadiene copolymer suitably has a weight average molecular weight (M_{w}) of at least 5,000, preferably at least 20,000, more preferably at least 50,000 and still more preferably at least 70,000. The molecular weight may be up to 400,000, and is preferably up to 300,000 and more preferably up to 200,000. Molecular weights for purposes of this invention are apparent molecular weights as determined by gel permeation chromatography against a polystyrene standard. GPC molecular weight determinations can be performed using an Agilent 1100 series liquid chromatograph equipped with two Polymer Laboratories PLgel 5 micrometer Mixed-C columns connected in series and an Agilent G1362A refractive index detector, or equivalent device, with tetrahydrofuran (THF) or other suitable solvent flowing at a rate of 1 mL/min and heated to a temperature of 35° C. as the eluent.

The brominated vinyl aromatic-butadiene copolymer contains at least 35% by weight bromine. It more preferably contains at least 50% by weight bromine or at least 60% by weight bromine. The brominated vinyl aromatic-butadiene copolymer can contain up to about 74% bromine, but as a practical matter bromine contents greater than about 70 weight percent are difficult to achieve without brominating aromatic rings of the vinyl aromatic units, which is less preferred. Bromine content can be determined from the increase in the weight of the polymer that occurs during bromination, and can also be measured using nuclear magnetic resonance (NMR) methods.

At least 90%, more preferably at least 95%, of the bromine is bonded to butadiene units. As much as 100% of the bromine may be bonded to butadiene units. Bromine bonded to the aromatic rings of the vinyl aromatic units contributes little to the flame retardant properties of the copolymer (unless a synergist is used) while adding significant mass and therefore cost, and for this reason preferably is minimized or avoided altogether. The sites of bromine bonds and therefore the proportion of bromine that is bonded to butadiene units can be determined using NMR methods.

At least 60, at least 70, at least 75, at least 80, at least 85 or at least 90% of the butadiene units of the starting polymer may be brominated, but which it is meant at least one and preferably two bromine atoms are present. Up to 100% of the butadiene units may be brominated. A practical upper limit is generally up to 95%, up to 98% or up to 99%. In particular embodiments, from 60 to 80%, from 70 to 80%, from 70 to 90%, from 80 to 90%, from 80 to 100% or from 90 to 100% of the butadiene units may be brominated. The proportion of butadiene units that are brominated can be determined using NMR methods.

The brominated vinyl aromatic-butadiene copolymer may contain a small amount of chlorine (such as up to 5% by weight), which preferably is aliphatically bound.

The brominated vinyl aromatic-butadiene copolymer should have a 5% weight loss temperature (5% WLT) of at least 200° C. and preferably at least 220° C., more preferably at least 240° C. and most preferably at least 250° C. The 5% WLT is preferably no greater than 300° C. and more preferably no greater than 280° C. 5% weight loss temperature is measured by thermogravimetric analysis as follows: 10 milligrams of the polymer is analyzed using a TA Instruments model Hi-Res TGA 2950 or equivalent device, with a 60 milliliters per minute (mL/min) flow of gaseous nitrogen and a heating rate of 10° C./min over a range of from room temperature (nominally 25° C.) to 600° C. This removes volatiles from the sample, and then causes the sample to thermally decompose, leading to a reduction in mass. The reduction in mass (after volatiles are removed) that occurs in the temperature range 100° C. to about 300° C. is attributed to the loss of bromine (as Br₂ and/or HBr) and/or the degradation of the polymer that results due to the action of the Br₂ and/or HBr that is produced. The mass of the sample at 100° C. (i.e., after volatiles are removed) is recorded, and the sample mass is monitored during the remainder of the heating step. The temperature at which the sample has lost 5% of its weight at 100° C. is designated the 5% weight loss temperature (5% WLT).

The brominated vinyl aromatic-butadiene copolymer may be produced by brominating a starting vinyl aromatic copolymer with a quaternary ammonium tribromide as described, for example, in WO 2008/021417, and/or a quaternary phosphonium tribromide, as described in WO 2010/114637. In such a process, the starting polymer is contacted with the quaternary ammonium tribromide or quaternary phosphonium tribromide, typically in solution in a solvent for the starting copolymer, under conditions such that the starting materials react to produce a solution of the brominated styrene-butadiene polymer and a quaternary ammonium monobromide or quaternary phosphonium monobromide byproduct. The monobromide byproduct can be removed from the brominated copolymer using any convenient method. This process has the advantage of being very selective in that bromination occurs almost entirely at butadiene units, with the near-exclusion of bromination of the aromatic rings of the styrene units. In addition, the process produces very little bromination at tertiary carbon atoms and at allylic carbons, and so produces a brominated copolymer that has excellent thermal stability.

It is also possible to brominate the starting styrene-butadiene copolymer by partially brominating the copolymer using a quaternary ammonium tribromide or quaternary phosphonium tribromide followed by further bromination with elemental bromine, as described in WO 2009/134628.

The bromination also may be performed using a direct bromination process, in which the starting butadiene polymer is brominated with elemental bromine as described, e.g., in WO 2008/021418. An aliphatic alcohol may be present during the bromination reaction, also as described in WO 2008/021418. Residual bromine and other by-products can be removed from the resulting brominated styrene-butadiene copolymer solution, by extraction, washing, or other useful methods.

The starting vinyl aromatic-butadiene copolymer used in any of the foregoing bromination processes is a thermoplastic, elastomeric material that contains vinyl aromatic, butadiene and optionally other repeating units, of the type and in the relative proportions described above. The polymerized butadiene units do not take the form of particles dispersed within a poly(vinyl aromatic) matrix, as is the case with the impact modified styrenic polymer. The starting vinyl aromatic-butadiene copolymer is generally made in a solution polymerization process, in which the polymer remains dissolved until the polymerization is completed. The molecular weight of the starting copolymer as measured by gel permeation chromatography is similar to that of the brominated product, as bromination has at most a small effect on the hydrodynamic volume of the copolymer molecules.

The impact-modified styrenic polymer (IMSP) can be described generally as a styrenic polymer or polymer grafted to dispersed rubber particles. The rubber particles form a disperse phase having an average particle size that is typically from about 0.25 to 25 microns and more typically from 0.5 to 5 microns.

Suitable IMSPs include the well-known high-impact polystyrene (HIPS) and acrylonitrile-styrene-butadiene (ABS) resins. HIPS is a polystyrene containing dispersed and grafted rubber particles. The rubber particles are typically a polymer or copolymer of butadiene. HIPS is prepared by dispersing a previously-prepared polymeric rubber into styrene monomer, which is then polymerized in the presence of the rubber and a grafting or chain transfer agent. The polymeric rubber phase separates from the growing polystyrene chains to form dispersed rubber particles. ABS resins are made in a similar process, except the rubber is dispersed into a mixture of styrene and acrylonitrile monomers, which are copolymerized. Again, the polymeric rubber phase separates as the styrene/acrylonitrile copolymer increases in molecular weight.

Methods for making IMSPs such as HIPS and ABS resins are well-known. Among the many references describing methods of their manufacture are U.S. Pat. Nos. 3,767,527, 5,180,780, 5,194,491 and 5,240,993. HIPS and ABS resins are also widely commercially available. Examples of suitable commercially available HIPS and ABS resins include those sold by Styron LLC under the Styron™, and Magnum® trade names.

The brominated vinyl aromatic-butadiene copolymer is blended with the IMSP. The amount of the brominated vinyl aromatic-butadiene copolymer present in the blend is conveniently expressed in terms of the amount of bromine that the brominated copolymer provides to the blend. A blend may contain enough of the brominated vinyl aromatic-butadiene polymer to provide a bromine content within a range of from 0.1 percent by weight to 25 percent by weight, based upon blend weight. The bromine content in the blend (provided by the brominated vinyl aromatic-butadiene copolymer) may be, for example, from 1 to 20 percent by weight, from 2 to 20 weight percent, or from 5 to 15 weight percent. The amount of brominated vinyl aromatic-butadiene polymer that is needed to provide a given bromine content to the blend will of course depend on its bromine content. In general, however, as little as about 0.15 parts by weight of the brominated vinyl aromatic-butadiene polymer can be provided per 100 parts by weight of the IMSP (0.15 pphr). At least 3 pphr or at least 8 pphr of the brominated vinyl aromatic-butadiene polymer can be provided. Up to 100 pphr or more of the brominated vinyl aromatic-butadiene polymer can be present in the blend, but a preferred maximum amount is 40 pphr, a more preferred maximum amount is 25 pphr.

In some embodiments, enough of the brominated copolymer is present in the blend to provide the blend with at least a V-2 rating on the UL-94 vertical flammability test. In the UL-94 test, a V-2 rating is assigned if the test specimen stops burning within 30 seconds after the igniting flame is removed; this rating permits some dripping of flaming particles. The V-2 rating is similar, except that any drips must not be inflamed. A V-0 rating requires the specimen to stop burning within 10 seconds of flame removal; as with the V-1 rating, drips are allows so long as they are not inflamed. In some embodiments, the blend can have a V-1 or even V-0 rating on that test. The amount of brominated copolymer that is needed to achieve these ratings will depend on various factors, including the bromine content of the copolymer (which affects the bromine content of the blend), as well as the particular IMSP that is selected.

The brominated vinyl aromatic-butadiene copolymer can be blended with the IMSP in any convenient manner. Care should be taken to minimize the thermal degradation (and loss of bromine) of the brominated copolymer during any blending step(s). Solution or melt blending methods are both suitable. Melt-blending can be performed as part of a melt-processing operation to form an article from the resulting blend. Melt-blending can be performed by forming a masterbatch or concentrate of the brominated copolymer in a small amount of IMSP, followed by letting the masterbatch or concentrate down into more of the IMSP to form the final blend.

The brominated copolymer usually is not fully miscible in the IMSP, and as a result tends to form small (0.5 to 50 μm, more typically 1 to 25 μm) domains in the IMSP when it is well-dispersed therein. Blending methods suitably are selected to obtain such a well-dispersed mixture. Despite the less-than-full miscibility, the brominated copolymer exhibits little blooming to the surface of the blend, probably because of its high molecular weight, which inhibits transport of the copolymer molecules through the IMSP matrix.

Blends of the invention are generally useful in the same applications as the neat IMSP resin. The articles are in generally fully compact or nearly so, having a bulk density of at least 750 kg/m³, more preferably at least 900 kg/m³, and a pore volume (as measured by immersion methods) of no greater than 20%, preferably no greater than 5%. Thus, for example, the blends are useful to make housings for consumer and business electronics such as computers, cellular telephones, personal digital assistant (PDA) devices, televisions, stereos, computer game consoles, various types of modem devices, among many others; linings for consumer appliances such as refrigerators and freezers; storage cases, storage boxes, food storage ware, pipe and many kinds of toys.

Articles can be made from blends of the invention using conventional melt-processing methods such as extrusion, injection molding, compression molding, casting, and the like. In each case, the melt processing operation can be conducted in any convenient manner. The melt processing operation can be conducted in a manner that is entirely conventional, but for the presence of the brominated copolymer. It is preferred to conduct the melt-processing operation under conditions that minimize the exposure of the brominated copolymer to very high temperatures. Thus, maximum temperatures below 220° C. are preferred, and if higher temperatures become necessary, it is preferred to minimize the time during which the brominated copolymer is exposed to such higher temperatures.

Various other materials can be present in the blend and/or during such a melt processing operations. These include, for example, various lubricants such as barium stearate or zinc stearate; UV stabilizers, thermal stabilizers, pigments or other colorants, plasticizers, FR synergists, IR blockers or attenuators, fillers, reinforcing agents (such as reinforcing fibers and platelets), melt flow promoters, other FR agents (including, for example, various phosphorus- and/or chlorine-containing compounds), other halogenated FR agents and/or non-halogenated FR agents, FR synergists, corrosion inhibitors, preservatives, biocides, antioxidants, and the like, as may be useful in the particular melt processing operation. In general, any or all of these can be used for their ordinary functions in the same manner as when the brominated copolymer is not present.

It is preferred to include one or more thermal stabilizers in any melt-processing operation, to help stabilize the brominated copolymer against loss of bromine and against certain cross-linking reactions that can occur once bromine is lost from the copolymer. Among these are alkyl phosphite compounds and epoxy compounds. Suitable alkyl phosphites are described in “Plastic Additive Handbook”, edited by H. Zweifel, 5^{th} Ed., p. 441 (2001). The alkyl phosphite compound contains at least one

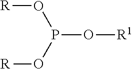

group, in which each R group is an unsubstituted or substituted alkyl group. The two R groups together may form a divalent group, which may be substituted, that bonds to the adjacent —O— atoms through aliphatic carbon atoms to form a ring structure that includes the —O—P—O— linkage. Specific examples of useful alkyl phosphites include bis(2,4-dicumylphenyl)pentaerythritol diphosphite, distearylpentaerythritol diphosphite and di(2,4-di-(t-butyl)phenyl)pentaerythritol diphosphite. These are commercially available as Doverphos™ S-9228 (Dover Chemical Corporation), Doverphos™ S-682 (Dover Chemical Corporation) and Irgafos™ 126 (Ciba Specialty Chemicals), respectively.

Epoxy compounds that are useful as thermal stabilizers contain on average at least one and preferably two or more epoxide groups per molecule. The epoxy compound preferably has an equivalent weight per epoxide group of no more than 2000, preferably no more than 1000 and even more preferably no more than 500. The molecular weight of the epoxy compound is at least 1000 in preferred embodiments. The epoxy compound may be brominated. A variety of commercially available epoxy resins are suitable. These may be based, for example, on a bisphenol compound such as one of the various diglycidyl ethers of bisphenol A. They may be based on a brominated bisphenol compound. The epoxy compound may be an epoxy novolac resin or an epoxy cresol novolac resin. The epoxy compound may be an entirely aliphatic material, such as a diglycidyl ether of a polyether diol or an epoxidized vegetable oil. Examples of commercially available epoxy compounds that are useful herein include F2200HM and F2001 (from ICL Industrial Products), DEN 439 (from The Dow Chemical Company), Araldite ECN-1273 and ECN-1280 (from Huntsman Advanced Materials Americas, Inc.), and Plaschek 775 (from Ferro Chemical Co.).

Other stabilizers and/or acid scavengers can be present, instead of or addition to the alkyl phosphite and the epoxy compound. Examples of such materials include, for example, inorganic materials such as tetrasodium pyrophosphate, hydrocalumite, hydrotalcite and hydrotalcite-like clays; polyhydroxyl compounds having a molecular weight of 1000 or below such as pentaerythritol, dipentaerythritol, glycerol, xylitol, sorbitol or mannitol, or partial esters thereof; and organotin stabilizers which may be allylophilic and/or dieneophilic. The organotin compounds include, for example, alkyl tin thioglycolates, alkyl tin mercaptopropionates, alkyl tin mercaptides, alkyl tin maleates and alkyl tin (alkylmaleates), wherein the alkyls are selected from methyl, butyl and octyl. Suitable organotin compounds are available commercially from Ferro Corporation (i.e., Thermchek™ 832, Thermchek™ 835), and Baerlocher GmbH (i.e., Baerostab™ OM 36, Baerostab™ M25, Baerostab™ MSO, Baerostab™ M63, Baerostab™ OM 710S).

An advantage of the invention is that the blends exhibit good flame performance (as measured by certain standardized flammability tests) and other useful characteristics even when certain materials are absent from the blend. Thus, for example, although metal-containing FR synergists such as those mentioned above may be present, they are generally unnecessary. Accordingly, in some embodiments, the blend contains no more than 0.05 weight percent of antimony oxide and/or a metal phthalocyanine, and preferably is devoid of each of them. Similarly, a fading dye may be present but is not necessary, and in some embodiments the blend contains no more than 0.1 part by weight per million of a fading dye or pigment and preferably is devoid thereof. Brominated compounds having a molecular weight of 1500 or less may be present, but are not necessary and in some embodiments the blend preferably contains no more than 0.5 weight percent of such compounds and is preferably devoid thereof.

The following examples are provided to illustrate the invention, but not to limit the scope thereof. All parts and percentages are by weight unless otherwise indicated.

### EXAMPLE 1 AND COMPARATIVE SAMPLE A

A styrene-butadiene triblock copolymer is brominated using tetraethyl ammonium tribromide as the brominating agent. The starting triblock copolymer is an elastomer that contains a central butadiene block and terminal polystyrene blocks. The polystyrene blocks together constitute 34 weight percent of the starting copolymer. The weight average molecular weight of the starting copolymer is 143,000 and the polydispersity is 1.1. 83% of the butadiene units are 1,2-butadiene units.

9 g of the starting copolymer are added to a 250-mL round-bottom flask equipped with overhead stirring, addition funnel and a nitrogen inlet, together with 66 g of dichloromethane. To a separate 250-mL round bottom flask are added 25.2 g (0.12 mol) of tetraethylammonium bromide and 41 g of deionized water. 16.0 g (0.10 mol) of bromine is added, which produces rust-red solids and raises the temperature of the solution to 31° C. The solids are dissolved by adding 12 g of dichloromethane, resulting in a two-phase liquid system and further raising the temperature of the solution to 34° C. The two-phase solution is transferred to an addition funnel, using 16 g of dichloromethane to aid the transfer. The entire solution (both organic and aqueous layers) is added in one rapid addition to the polymer solution, raising the temperature of the polymer solution from 26° C. to 34° C. After 2 hours, a reaction aliquot is precipitated into 2-propanol, the resulting slurry is filtered, and the solids are washed with 2-propanol. After drying, the solid sample is analyzed by proton NMR, which indicates that the brominated copolymer contains 66% by weight bromine (corresponding to the addition of two Br atoms to essentially all the butadiene units). No measurable ring bromination occurs. This brominated copolymer has a 5% WLT of 267° C.

A masterbatch is formed by extruding 36.2 parts of the brominated copolymer, 43.3 parts of a high impact polystyrene (Styron® 487, from Styron LLC), 9.7 parts of an epoxy cresol novolac resin, 7.8 parts of a phosphite stabilizer and 3 parts of a poly(tetrafluoroethene) resin through a lab-scale twin screw extruder. The highest temperature zone is set at 180° C. to minimize thermal degradation of the brominated copolymer. The extrudate is cut into 4-5-mm pellets. The masterbatch pellets contain 24.2% by weight bromine, all contributed by the brominated copolymer.

Blends of the same HIPS and the masterbatch are made at different concentrations of masterbatch by processing the masterbatch pellets and pellets of the HIPS resin.

Test bars for flammability testing are made by injection molding the blends using an Arburg Model 221-22-250 injection molding machine. The test bars are then evaluated on the UL-94 flammability test. A blend (Example 1) that contains 10% by weight bromine has a V-0 rating on this test.

Comparative Sample A is made in the same general manner, except that the masterbatch contains 29.6 parts of hexabromocyclododecane, 50 parts of the same HIPS resin, 9.7 parts of the epoxy cresol novolac resin, 7.7 parts the phosphite stabilizer and 3 parts of the poly(tetrafluoroethene) resin. When this masterbatch is let down into more HIPS at levels that provide up to 10% bromine in the blend, the blend fails to attain better than a V-1 rating. The V-1 rating is achieved at a bromine content of 7.5%; at a bromine level of 10% by weight, the hexabromocyclododecane plasticizes the HIPS so much that it fails to retreat from the ignition source. The HIPS drips, and the blend is no longer able to attain even a V-2 rating.

These results demonstrate how better performance on the UL-94 flammability test can be obtained when the brominated vinyl aromatic-butadiene copolymer is used as a flame retardant, rather than the industry standard (HBCD). With HBCD, performance peaks with only a V-1 rating; adding more HBCD does not further improve performance, but instead diminishes it. The brominated vinyl aromatic-butadiene polymer, on the other hand, improves performance on the UL-94 as the loading increases, so it is possible to obtain a V-0 rating on this test.

1. An impact-modified styrenic polymer resin composition comprising an impact-modified styrenic polymer resin having a brominated vinyl aromatic-butadiene copolymer blended therein, wherein the brominated copolymer (a) has a molecular weight of at least 5,000, as determined by gel permeation chromatography against a polystyrene standard, (b) contains 2.5 to 85 mole-% styrenic monomer units and 15 to 97.5 mole-% butadiene units, (c) has a bromine content of at least 50% by weight of which at least 90 mole percent is bonded to butadiene units and (d) has a five percent weight loss temperature, as determined by thermogravimetric analysis, of at least 200° C.

2. The impact-modified styrenic polymer resin composition is in the form of a shaped article having a bulk density of at least 900 kg/m³.

3. The impact-modified styrenic polymer resin composition of claim 2, wherein the impact-modified styrenic polymer resin is selected from a group consisting of high impact polystyrene and acrylonitrile-butadiene-styrene copolymer.

4. The impact-modified styrenic polymer resin composition of claim 3, wherein the brominated polymeric flame retardant is further characterized by having a five percent weight loss temperature, of 220 to 280° C. as determined by thermogravimetric analysis.

5. The impact-modified styrenic polymer resin composition of claim 4, which contains 2 to 20 weight percent bromine contributed by the brominated vinyl aromatic-butadiene copolymer.

6. The impact-modified styrenic polymer resin composition of claim 5 which contains 8 of 25 weight percent of the brominated vinyl aromatic-butadiene copolymer.

7. The impact-modified styrenic polymer resin composition of claim 3 wherein the impact-modified styrenic polymer resin has a melt flow index greater than 0.2 grams per minute and less than 10 grams per minute as determined according to ASTM D1238 at 200 degrees Celsius using a 5 kilogram weight.

8. The impact-modified styrenic polymer resin composition of claim 3 which contains no more than 0.05 weight percent of a metal phthalocyanine.

9. The impact-modified styrenic polymer resin composition of claim 8 which contains no more than 0.1 part by weight per million of a fading dye or pigment.

10. The impact-modified styrenic polymer resin composition of claim 9 which contains no more than 0.5 weight percent of brominated compounds that have a molecular weight of 1500 or less.

11. The impact-modified styrenic polymer resin composition of claim 3, further comprising at least one organic stabilizer compound.

12. The impact modified polymer resin composition of claim 3, further characterized comprising at least one chlorine or phosphorous-containing compound.

13. A method for making an impact-modified styrenic polymer resin article, comprising melt-processing an impact-modified styrenic polymer resin in the presence of a brominated vinyl aromatic-butadiene copolymer to form a shaped melt, and cooling the shaped melt to form the impact-modified styrenic polymer resin article, wherein the brominated copolymer (a) has a molecular weight of at least 10,000, as determined by gel permeation chromatography against a polystyrene standard, (b) contains 2.5 to 85 mole-% styrenic monomer units and 15 to 97.5 mole-% butadiene units, (c) has a bromine content of at least 50% by weight of which at least 90 mole percent is bonded to butadiene units and (d) has a five percent weight loss temperature, as determined by thermogravimetric analysis, of at least 200° C.

14. The method of claim 13 wherein the brominated copolymer has a five percent weight loss temperature of at least 240° C. and no greater than 300° C.

15. The method of claim 14 wherein the melt-processing is performed at a temperature of 220° C. or below.

16. The method of claim 15 which is performed in the presence of no more than 0.05 weight percent of a metal phthalocyanine.

17. The method of claim 16 which is performed in the presence of no more than 0.1 part by weight per million of a fading dye or pigment.

18. The method of claim 17 which is performed in the presence of no more than 0.5 weight percent of brominated compounds that have a molecular weight of 1500 or less.
